(19) United States
(12) Patent Application Publication
(10) Pub. No.: US 2025/0225747 A1
(43) Pub. Date: Jul. 10, 2025

(54) IMAGE PROCESSOR, PROCESSING METHOD, STORAGE MEDIUM AND EXTENDED REALITY DISPLAY DEVICE

(71) Applicant: GravityXR Electronics and Technology Co., Ltd., NINGBO (CN)

(72) Inventors: Tao JIA, NINGBO (CN); Chaohao WANG, NINGBO (CN); Lei ZHAO, NINGBO (CN); Chengrui LE, NINGBO (CN); Shuang WANG, NINGBO (CN); Rui ZHANG, NINGBO (CN)

(73) Assignee: GravityXR Electronics and Technology Co., Ltd., NINGBO (CN)

(21) Appl. No.: 19/093,189

(22) Filed: Mar. 27, 2025

Related U.S. Application Data
(63) Continuation of application No. PCT/CN2023/106699, filed on Jul. 11, 2023.
(63) Continuation of application No. PCT/CN2023/106703, filed on Jul. 11, 2023.
(63) Continuation of application No. PCT/CN2023/106705, filed on Jul. 11, 2023.

(30) Foreign Application Priority Data
Sep. 27, 2022 (CN) 202211184446.5
Sep. 27, 2022 (CN) 202211184496.3
Sep. 27, 2022 (CN) 202211185033.9

(51) Int. Cl. G06T 19/00; G06F 3/01; G06T 3/4053; G06T 5/50; G06T 5/80; G06T 19/20

(52) U.S. Cl. CPC G06T 19/006; G06F 3/013; G06T 3/4053; G06T 5/50; G06T 5/80; G06T 19/20; G06T 2207/20221; G06T 2219/2012

(57) ABSTRACT

The disclosure provides an image processor, an image processing method, a computer-readable storage media and an extended reality display device. The image processor includes a display pipeline. The display pipeline integrates a software processing unit and at least one hardware image processing unit, and is configured to: obtaining an eye movement signal and motion perception information of a user, and obtaining a virtual rendering image to be processed; using a first software configured in the software processing unit and the at least one hardware image processing unit to perform optical correction on the virtual rendering image, according to the eye movement signal and the motion perception information; and using a second software configured in the software processing unit and the at least one hardware image processing unit to perform display compensation correction on the virtual rendering image, according to the eye movement signal and the motion perception information.

This application is a continuation of three PCT applications filed on Jul. 11, 2023, with international patent application numbers of PCT/CN2023/106699, PCT/CN2023/106703, and PCT/CN2023/106705. The PCT application PCT/CN2023/106699 claims the priority of a patent application filed on Sep. 27, 2022, with a Chinese application number of 202211184446.5, and a title of “Image processor, processing method, storage medium, and extended reality display device”, the entire contents of which are incorporated herein by reference. The PCT application PCT/CN2023/106703 claims the priority of a patent application filed on Sep. 27, 2022, with a Chinese application number of 202211184496.3, and a title of “Image processor, processing method, storage medium, and extended reality display device”, the entire contents of which are incorporated herein by reference. The PCT application

PCT/CN2023/106705 claims the priority of a patent application filed on Sep. 27, 2022, with a Chinese application number of 202211185033.9, and a title of “Image processor, processing method, storage medium, and extended reality display device”, the entire contents of which are incorporated herein by reference.

### FIELD

The disclosure relates to extended reality display technology, in particular to an image processor, an image processing method, a computer-readable storage medium and an extended reality display device.

### BACKGROUND

Extended reality (XR) display technology refers to the technology that combines reality and virtuality through computers to create a human-computer interactive virtual environment, including but not limited to augmented reality (AR) display technology, virtual reality (VR) display technology, and mixed reality (MR) display technology. By integrating these three visual interaction technologies, the extended reality display technology can provide users with immersive experiences of seamless transition between the virtual world and the real world.

For the demands of the image compensation and correction in the XR field, existing display compensation algorithms is usually insufficient to support complex and delicate compensation, and the compensation effect is limited. In order to overcome the above-mentioned shortcoming of existing technologies, this field urgently needs an image processing technology that combines an eye movement signal and motion perception information of a user to perform optical correction and display compensation correction, and by setting and reusing hardware image processing unit to improve the storage, processing and transmission efficiency of data, thereby enhancing the image display quality of XR display device based on limited software and hardware resources.

### SUMMARY

A brief overview of one or more embodiments is provided below to provide a basic understanding of these embodiments. The summary is not an extensive overview of all of the embodiments that are contemplated, and is not intended to identify key or decisive elements in all embodiments. The sole purpose of the summary is to present some concepts of one or more embodiments in a simplified form as a prelude to the more detailed description that is presented later.

In order to overcome the above-mentioned shortcomings of existing technologies, the disclosure provides an image processor, an image processing method, a computer-readable storage medium and an extended reality display device.

In one embodiment, the image processor provided in one embodiment of the disclosure includes a display pipeline, and the display pipeline integrates a software processing unit and at least one hardware image processing unit, and is configured to: obtaining an eye movement signal and motion perception information of a user, and obtaining a virtual rendering image to be processed; using a first software configured in the software processing unit and the at least one hardware image processing unit to perform optical correction on the virtual rendering image, according to the eye movement signal and the motion perception information; and using a second software configured in the software processing unit and the at least one hardware image processing unit to perform display compensation correction on the virtual rendering image, according to the eye movement signal and the motion perception information. In this way, the disclosure can combine an eye movement signal and motion perception information of a user to preform optical correction and display compensation correction, and improve the storage, processing, and transmission efficiency of data by setting and reusing hardware image processing unit, thereby enhancing the image display quality of XR display devices based on limited software and hardware resources.

Correspondingly, the image processing method provided according to one embodiment of the disclosure includes following steps: obtaining an eye movement signal and motion perception information of a user, and obtaining a virtual rendering image to be processed; using a first software configured in a software processing unit and at least one hardware image processing unit to perform optical correction on the virtual rendering image, according to the eye movement signal and the motion perception information; and using a second software configured in the software processing unit and the at least one hardware image processing unit to perform display compensation correction on the virtual rendering image, according to the eye movement signal and the motion perception information. In this way, the disclosure can combine an eye movement signal and motion perception information of a user to preform optical correction and display compensation correction, and improve the storage, processing, and transmission efficiency of data by setting and reusing hardware image processing unit, thereby enhancing the image display quality of XR display devices based on limited software and hardware resources.

Correspondingly, the extended reality display device provided according to one embodiment of the disclosure includes an eye tracker, a motion sensor, a main processor, an image processor and a display terminal. The eye tracker is used to collect an eye movement signal of a user. The motion sensor is used to collect motion perception information of the user. The main processor is used to output a virtual rendering image to be processed. The coprocessor can use the image processor provided according to embodiments of the disclosure, and the image processor is respectively connected to the eye tracker, the motion sensor and the main processor to obtain the eye movement signal, the motion perception information and the virtual rendering image. The display terminal is connected to the image processor to obtain and display a corrected image that has undergone optical correction and display compensation correction performed by the image processor.

In addition, the image processor provided in another embodiment of the disclosure includes a display pipeline. The display pipeline integrates a software processing unit and at least one hardware image processing unit, and is configured to: obtaining an eye movement signal and motion perception information of a user, and obtaining a first image to be processed; using a first software configured in the software processing unit and the at least one hardware image processing unit to perform distortion correction on the first image; using a second software configured in the software processing unit and the at least one hardware image processing unit to perform compression processing on the first image, according to the eye movement signal; and transmitting a second image obtained through the distortion correction and the compression processing to the display terminal for image display. In this way, the disclosure can provide compression processing function for high resolution display of local regions according to the eye movement signal of the user, and improve the storage, processing, and transmission efficiency of data by setting and reusing hardware image processing unit, thereby meeting high-resolution display remand of XR display devices based on limited software and hardware resources.

Correspondingly, the image processing method provided according to another embodiment of the disclosure includes following steps: obtaining an eye movement signal and motion perception information of a user, and obtaining a first image to be processed; using a first software configured in the software processing unit integrated in the display pipeline and the at least one hardware image processing unit integrated to perform distortion correction on the first image; using a second software configured in the software processing unit and the at least one hardware image processing unit to perform compression processing on the first image, according to the eye movement signal; and transmitting a second image that has undergone the distortion correction and the compression processing to the display terminal for image display. In this way, the disclosure can provide compression processing function for high-resolution display of local regions according to the eye movement signal of the user, and improve the storage, processing, and transmission efficiency of data by setting and reusing hardware image processing unit, thereby meeting high-resolution display remand of XR display devices based on limited software and hardware resources.

Correspondingly, the extended reality display device provided according to another embodiment of the disclosure includes an eye tracker, a main processor, a coprocessor and a display terminal. The eye tracker is used to collect an eye movement signal of a user. The main processor outputs a first image with or without gaze point rendering compression, and the gaze point rendering compression is according to the eye movement signal. The coprocessor can use the image processor provided according to another embodiment of the disclosure, and the image processor is respectively connected to the eye tracker and the main processor to obtain the first image and the eye movement signal. The display terminal is connected to the image processor to obtain and display a second image that has undergone distortion correction and compression processing performed by the image processor.

In addition, the image processor provided in another embodiment of the disclosure is configured to: obtaining an eye movement signal of a user and a forth image to be processed; determining gaze region in the forth image, according to the eye movement signal; and performing super-resolution processing on the gaze region to obtain a fifth image with local resolution of the gaze area reaching the target resolution.

Correspondingly, the image processing method provided according to another embodiment of the disclosure includes following steps: obtaining an eye movement signal of a user and a forth image to be processed; determining gaze region in the forth image, according to the eye movement signal; and performing super-resolution processing on the gaze region to obtain a fifth image with local resolution of the gaze area reaching the target resolution.

Correspondingly, the extended reality display device provided according to another embodiment of the disclosure includes an eye tracker, a main processor, a coprocessor and a display terminal. The eye tracker is used to collect an eye movement signal of a user. The main processor outputs a forth image with or without gaze point rendering compression, and the gaze point rendering compression is according to the eye movement signal. The coprocessor can use the image processor provided according to another embodiment of the disclosure, and the image processor is respectively connected to the eye tracker and the main processor to obtain the forth image and the eye movement signal. The display terminal is connected to the image processor to obtain and display a fifth image that has undergone super-resolution processing performed by the image processor.

In addition, the computer-readable storage media provided according to one embodiment of the disclosure stores a computer instruction thereon. The image processing method according to each embodiment of the disclosure is implemented when the computer instruction is executed by a processor.

### BRIEF DESCRIPTION OF THE DRAWINGS

The above features and advantages of the disclosure will be better understood after reading the detailed description of the embodiments of the present disclosure in conjunction with the following figures. In the figures, components are not necessarily drawn to scale, and components having similar related features may have the same or similar reference numerals.

FIG. 1 shows a schematic diagram of the extended reality display device provided according to some embodiments of the disclosure.

FIG. 2 shows a flowchart of the image processing method provided according to some embodiments of the disclosure.

FIG. 3 shows a schematic diagram of frame-by-frame image correction processing provided according to some embodiments of the disclosure.

FIG. 4 shows a schematic diagram of distortion correction provided according to some embodiments of the disclosure.

FIG. 5 shows a schematic diagram of uniformity correction provided according to some embodiments of the disclosure.

FIG. 6 shows a schematic diagram of color separation correction provided according to some embodiments of the disclosure.

FIG. 7 shows a schematic diagram of color accuracy compensation correction provided according to some embodiments of the disclosure.

FIG. 8 shows a schematic diagram of device-by-device image correction processing provided according to some embodiments of the disclosure.

FIG. 9 shows a schematic diagram of the extended reality display device provided according to some embodiments of the disclosure.

FIG. 10 shows a flowchart of the image processing method provided according to some embodiments of the disclosure.

FIG. 11 shows a flowchart of the composite compressed image provided according to some embodiments of the disclosure.

FIG. 12 shows a schematic diagram of the image local compression processing provided according to some embodiments of the disclosure.

FIG. 13 shows a flowchart of the image processing method provided according to some embodiments of the disclosure.

FIG. 14 shows a schematic diagram of the extended reality display device provided according to some embodiments of the disclosure.

### DETAILED DESCRIPTION OF EMBODIMENTS

The embodiments of the disclosure are described in the following detailed description. Although the description of the disclosure will be described in conjunction with some embodiments, this is not a limitation of the disclosure. On the contrary, the disclosure is described in connection with the embodiments to cover other alternatives or modifications that are possible in the embodiments of the disclosure. In order to provide a thorough understanding of the disclosure, many specific details are included in the following description. The disclosure may also be practiced without these details. In addition, some specific details are omitted in the description in order to avoid confusing or obscuring the disclosure.

In the description of the disclosure, it should be noted that the terms “installation”, “connecting”, and “connected” should be understood broadly unless explicitly stated and defined otherwise. For example, the terms “installation”, “connecting”, and “connected” may be either a fixed connection, a detachable connection, or an integral connection; the terms may be either a mechanical connection or an electrical connection; the terms also may be either a direct connection, an indirect connection through an intermediate medium, or an internal connection between two components. The specific meaning of the above terms in the disclosure can be understood in the art.

In addition, “up”, “down”, “left”, “right”, “top”, “bottom”, “horizontal”, “vertical” used in the following description shall be understood as the orientation described in the paragraph and shown in the related figure. The relative term is used for convenience of description only, and does not mean that the device described therein is to be manufactured or operated in the specific orientation, and therefore should not be construed as limiting the disclosure.

Understandably, although the terms “first”, “second”, “third”, etc. may be used to describe various components, regions, layers and/or portions to distinguish different components, regions, layers and/or portions, the order of these components, regions, layers and/or portions described above should not be limited by the terms. Therefore, a first component, region, layer and/or portion mentioned below may be also mentioned as a second component, region, layer and/or portion without departing from some embodiments of the disclosure.

As mentioned above, for the demands of image compensation and correction in the XR field, existing display compensation algorithms are generally implemented in hardware modules on the display driver IC (DDIC) at screen end, while most existing optical compensation algorithms are generally implemented in software on the graphics processing unit (GPU). However, in display algorithms implemented through DDIC hardware, existing technologies is usually insufficient to support complex and delicate compensation due to limitations in manufacturing process and hardware resources of DDIC, and the compensation effect is limited. In optical distortion compensation schemes implemented through GPU software, there are drawbacks of high-power consumption and high latency. In addition, there are several new display defects that require compensation algorithms to be designed in the combination of Micro OLED display devices and pancake lens optical devices in XR display devices, as well as in the combination of LCD displays and pancake lens optical devices in 0D/1D/2D backlight modules.

In order to overcome the above-mentioned shortcomings of existing technologies, the disclosure provides an image processor, an image processing method, a computer-readable storage medium and an extended reality display device, which can combine an eye movement signal and motion perception information of a user to perform optical correction and display compensation correction, and by setting and reusing hardware image processing units to improve the storage, processing, and transmission efficiency of data, thereby enhancing the image display quality of XR display devices based on limited software and hardware resources.

In some non-limiting embodiments, the image processing method provided by the disclosure can be implemented by the image processor provided by the disclosure. In one embodiment, the image processor can be independently configured in the form of a chip of a coprocessor in the extended reality display device provided by the disclosure, and also can be integrated into the main processor such as the Central Processing Unit (CPU) and the Graphics Processing Unit (GPU) of the extended reality display device provided by the disclosure through software programs and hardware units.

Furthermore, the image processor provided by the disclosure can be configured or connected a processing unit and a storage unit of software programs. The storage unit includes, but not limited to, the computer-readable storage medium provided by the disclosure, on which computer instructions are stored. The processing unit is connected to the storage unit and configured to execute the computer instructions stored on the storage unit to implement the above image processing method provided by the disclosure.

The working principle of the above image processor and the extended reality display device will be described below in conjunction with some embodiments of some image processing methods. In some non-limiting embodiments, the extended reality display device can use a system architecture of a coprocessor. The embodiments of these image processing methods only provide some non-limiting implementations of the disclosure, which is intended to clearly display the main idea of the disclosure, and provide some specific proposals that are convenient for the public to implement, rather than limiting all working manners or all functions of the image processing system and the extended reality display device. Similarly, the image processor and the extended reality display device is also only a non-limiting embodiment provided by the disclosure, and does not limit the implementation subject to each step in these image processing methods.

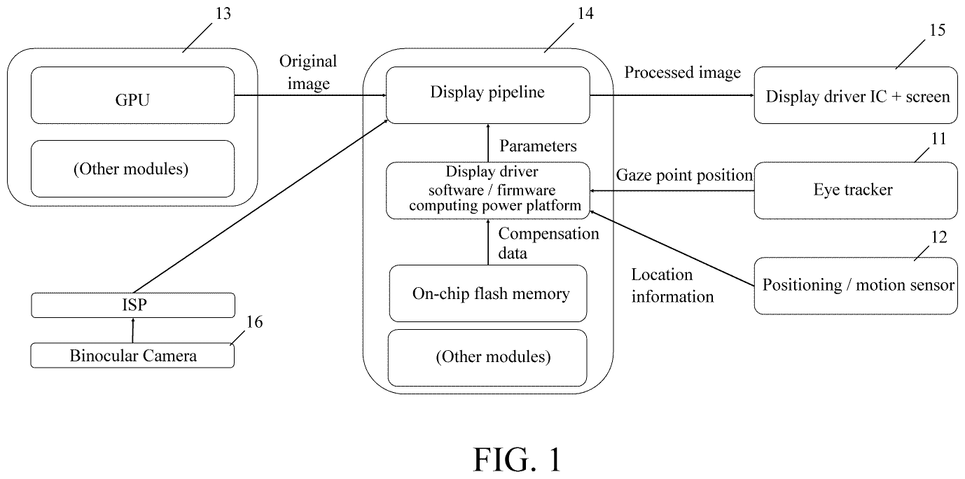

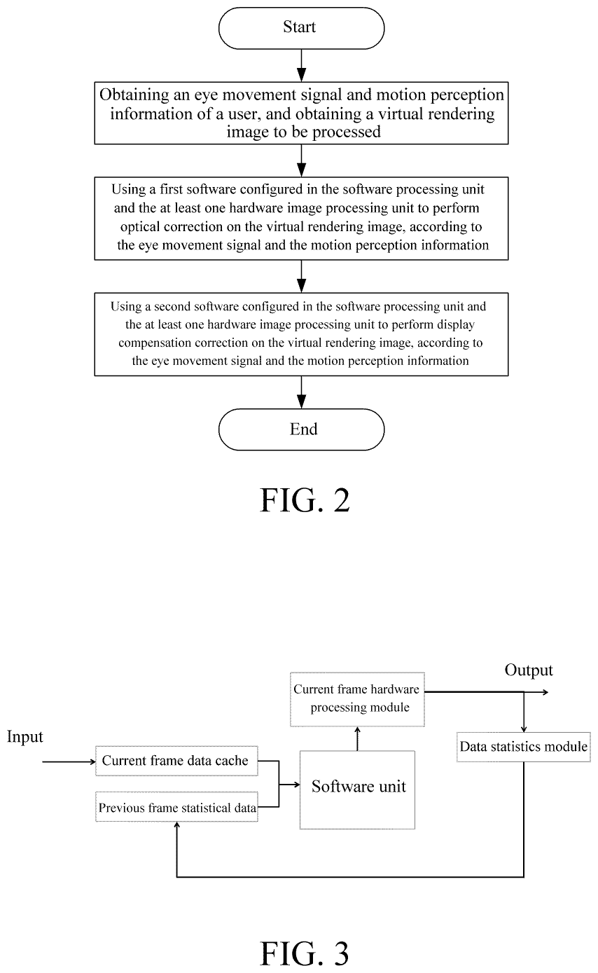

Please refer to FIG. 1 and FIG. 2. FIG. 1 shows a schematic diagram of the extended reality display device provided according to some embodiments of the disclosure. FIG. 2 shows a flowchart of the image processing method provided according to some embodiments of the disclosure.

As shown in FIG. 1, in some embodiments of the disclosure, the extended reality display device can be configured with an eye tracker 11, a motion sensor 12, a main processor 13, a coprocessor 14 and a display terminal 15. The eye tracker 11 is used to collect an eye movement signal of a user. The motion sensor 12 is used to collect motion perception information of the user. The main processor 13 is used to output a virtual rendering image to be processed. The coprocessor 14 can use the image processor provided in one embodiment of the disclosure. The coprocessor 14 is respectively connected to the eye tracker 11, the motion sensor 12 and the main processor 13 to obtain the eye movement signal, the motion perception information and the virtual rendering image. The display terminal 15 is connected to the coprocessor 14 to obtain and display a corrected image that has undergone optical correction and display compensation correction performed by the coprocessor 4014

Furthermore, the coprocessor 14 can be configured with a display pipeline. The display pipeline integrates a software processing unit and at least one hardware image processing unit, and is configured to use different software programs and the same hardware image processing unit to perform image processing processes such as optical correction and display compensation correction on the virtual rendering image, thereby improving the storage, processing, and transmission efficiency of data, thereby enhancing the image display quality of XR display devices based on limited software and hardware resources.

In one embodiment, the software processing unit configured in the display pipeline of the coprocessor 14 include but are not limited to optical correction unit and display compensation correction unit. The hardware image processing unit configured in the display pipeline can be selected from at least one of a transistor level cache memory, a weighted sum circuit, a mean calculation circuit, a filtering circuit, and a mapping circuit for pixel position relationship, used to store pixel data at multiple positions of a current frame and/or pixel data at multiple positions of at least one historical frame of the virtual rendering image, and/or perform hardening calculation of weighted sum, mean calculation, filtering, and/or pixel position mapping on these pixel data.

As shown in FIG. 2, during the process of image processing, the display pipeline can firstly obtain an eye movement signal and motion perception information of a user, and a virtual rendering image to be processed.

Herein, the eye movement signal includes but not limited to eye deviation angle, gaze position, gaze direction, and other data of the user. The display pipeline can be directly connected to the eye tracker 11 and obtain the eye movement signal directly from the eye tracker 11, or indirectly connected to the eye tracker 11 through the GPU or other image processing units of the main processor 13, and indirectly synchronously obtain the eye movement signal of the user through the main processor 13. In some embodiments, the coprocessor 14 can be configured with display driver software and/or firmware computing power platform. The display driver software and/or the firmware computing power platform are respectively connected to the eye tracker 11, the motion sensor 12, and the display pipeline. In the process of obtaining the eye movement signal of the user, the coprocessor 14 can firstly obtain the eye movement signal of the user from the eye tracker 11 through the display driver software and/or the firmware computing power platform, and perform eye tracking calculation to determine the gaze point position. Afterwards, the display driver software and/or the firmware computing platform can update the internal gaze point information of the system according to the gaze point position to construct an updated compression model, and transmit compression parameters of the updated compression model to the display pipeline for subsequent image processing.

In addition, the above motion perception information can be selected from X/Y/Z three degrees of freedom information of a head of the user and corresponding calculated yaw, pitch, and roll information, or six degrees of freedom information of the head of the user, including front/back, up/down, left/right, yaw, pitch, and roll. The virtual rendering image can be the original image generated by the GPU or other image processing units of the main processor 13. In some embodiments, the main processor 13 may also be connected to the eye tracker 11, configured to obtain the eye movement signal of the user from the eye tracker 11, and firstly perform gaze point rendering compression on the generated original virtual rendering image according to the eye movement signal, and then send the compressed gaze point rendering image to the coprocessor 14 to reduce the data transmission and processing load of the entire architecture.

As shown in FIG. 1 and FIG. 2, after obtaining the eye movement signal and the motion perception information of the user, and obtaining the virtual rendering image to be processed, the display pipeline can use the optical correction unit (i.e. the first software) configured therein, as well as at least one the hardware image processing unit integrated therein, to perform optical correction on the obtained virtual rendering image.

In one embodiment, the at least one hardware image processing unit includes a first memory. The first memory can store pixel data at multiple positions of a current frame of the virtual rendering image to be processed and/or pixel data at multiple positions of at least one historical frame of the virtual rendering image to be processed or already processed. Herein, processing can include the abovementioned optical correction processing, and image processing operations such as display compensation correction processing, spatial distortion correction processing, and composite compression processing mentioned later. As shown in FIG. 3, during the process of performing optical correction, the optical correction unit (i.e. the first software) configured in the display pipeline can firstly determine a target pixel point corresponding to the gaze point and at least one related pixel point according to the eye movement signal and the motion perception information of the user, and then obtain the pixel data at multiple corresponding positions of the current frame and/or the pixel data at multiple corresponding positions of the at least one historical frame from the first memory. Afterwards, the optical correction unit (i.e. the first software) can perform the optical correction on the virtual rendering image, according to the obtained eye movement signal, the motion perception information, and the pixel data at multiple positions of the current frame and/or the pixel data at multiple positions of the at least one historical frame.

Furthermore, the at least one hardware image processing unit further includes at least one hardening calculation circuit. The at least one hardening calculation circuit is selected from at least one of a weighted sum circuit, a mean calculation circuit, a filtering circuit, and a mapping circuit for pixel position relationship. During the process of preforming the optical correction on the virtual rendering image, the display pipeline can use the first software and the at least one hardening calculation circuit to perform the optical correction on the virtual rendering image according to the eye movement signal, the motion perception information, and the pixel data at multiple positions of the current frame and/or the pixel data at multiple positions of the at least one historical frame.

For example, the display pipeline can firstly input raw data of the target pixel point and the at least one related pixel point (i.e. the pixel data at multiple positions of the current frame and/or the pixel data at multiple positions of the at least one historical frame) into the at least one hardening calculation circuit, such as the weighted sum circuit, the mean calculation circuit, the filtering circuit, and the mapping circuit for pixel position relationship, to perform hardening calculation to obtain a corresponding result of the hardening calculation. Then, the first software can be used to perform the optical correction on the virtual rendering image according to the result of the hardening calculation.

In this way, the disclosure can reuse a large amount of pixel data at multiple positions of multiple frames of images through the first memory during the frame by frame optical correction, greatly reducing the demand for hardware storage resources and eliminating the demands for repeated calculation and storing of pixel data in the image, thereby enhancing the image display quality of XR display devices based on limited software and hardware resources.

In addition, as shown in FIG. 1 and FIG. 2, after obtaining the eye movement signal and the motion perception information of the user, and obtaining the virtual rendering image to be processed, the display pipeline can also use the display compensation correction unit (i.e. the second software) configured therein, as well as the at least one hardware image processing unit integrated therein, to perform display compensation correction on the obtained virtual rendering image.

As mentioned above, the at least one hardware image processing unit includes the first memory. The first memory can store pixel data at multiple positions of a current frame and/or pixel data at multiple positions of at least one historical frame. As shown in FIG. 3, during the process of performing display compensation correction, the display compensation correction unit (i.e. the second software) configured in the display pipeline can also determine the target pixel point corresponding to the gaze point and the at least one related pixel point according to the eye movement signal and the motion perception information of the user, and then obtain the pixel data at multiple positions of the current frame and/or the pixel data at multiple positions of the at least one historical frame from the first memory. Afterwards, the display compensation correction unit (i.e. the second software) can perform the display compensation correction on the virtual rendering image according to the eye movement signal, the motion perception information, and the pixel data at multiple positions of the current frame and/or the pixel data at multiple positions of the at least one historical frame.

Furthermore, the at least one hardware image processing unit also includes the at least one hardening calculation circuit, such as the weighted sum circuit, the mean calculation circuit, the filtering circuit, and the mapping circuit for pixel position relationship mentioned above. During the process of performing display compensation correction on the virtual rendering image, the display pipeline can use the second software and the at least one hardening calculation circuit to perform the display compensation correction on the virtual rendering image according to the eye movement signal, the motion perception information, the pixel data at multiple positions of the current frame and/or the pixel data at multiple positions of the at least one historical frame.

For example, the display pipeline can firstly input the raw data of the target pixel point and the at least one related pixel point (i.e. the pixel data at multiple positions of the current frame and/or the pixel data at multiple positions of the at least one historical frame) into the at least one hardening calculation circuit, such as the weighted sum circuit, the mean calculation circuit, the filtering circuit, and the mapping circuit for pixel position relationship, to perform hardening calculation to obtain the corresponding result of the hardening calculation. Then, the second software can be used to perform the display compensation correction such as distortion removal, uniformity correction, color separation removal, and/or color accuracy compensation on the virtual rendering image according to the result of the hardening calculation.

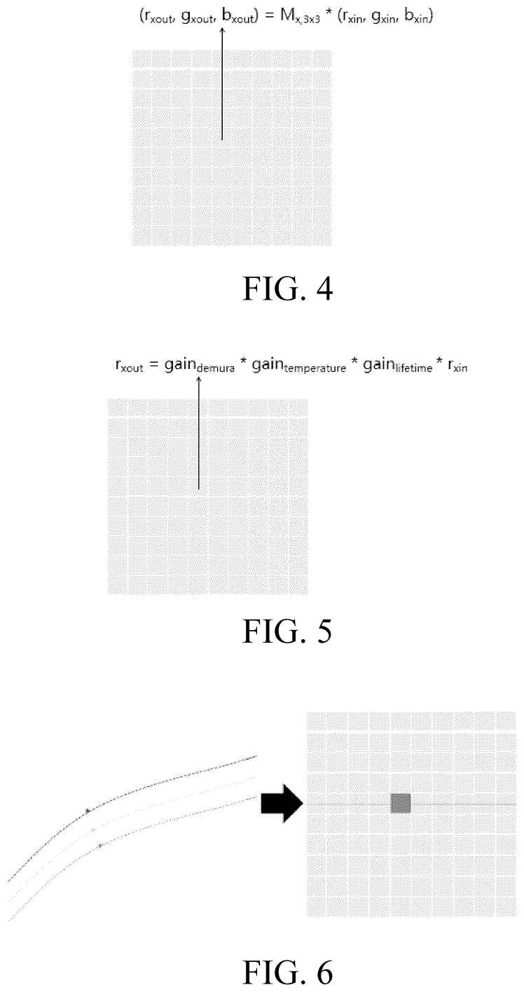

Please refer to FIG. 4 to FIG. 7 for details. FIG. 4 shows a schematic diagram of distortion correction provided according to some embodiments of the disclosure. FIG. 5 shows a schematic diagram of uniformity correction provided according to some embodiments of the disclosure. FIG. 6 shows a schematic diagram of color separation correction provided according to some embodiments of the disclosure. FIG. 7 shows a schematic diagram of color accuracy compensation correction provided according to some embodiments of the disclosure.

As shown in FIG. 4, the distortion correction is achieved based on the correspondence of pixel coordinates. In one embodiment, the pixel data of the target pixel (rxout, gxout, bxout) is determined according to 3×3 dimensional corresponding mapping relationship Mx, 3×3 of gaze point information, weight settings, and pixel position information (rxin, gxin, bxin) of the original image, mainly implemented based on pixel mapping circuit to improve image distortion and other issues.

As shown in FIG. 5, the principle of the uniformity correction is to determine the target pixel value rxout for each pixel according to the pixel position information rxin of the original image, and the gain coefficients related to the three dimensions of uniformity compensation gaindemura, temperature compensation gaintemperature, and lifetime compensation gainlife, mainly to correct uniformity of sub pixels.

As shown in FIG. 6, the color separation correction is the process of setting a weighted average coefficient for the pixel position information (rxin, gxin, bxin) of the original image, and performing a weighted average on data of nearby pixels of the target pixel point, in order to correspond the RGB three colors to the data of the target pixel point, mainly used to handle color separation caused by different degrees of image distortion on the RGB three colors.

As shown in FIG. 7, the color accuracy compensation correction is achieved by using a 3×3 dimensional matrix f3dlut to obtain the ratio of the RGB three colors of the target pixel, and then mapping the RGB data (rxin, gxin, bxin) of the original image to determine the pixel data (rxout, gxout, bxout) of the target pixel, mainly used to compensate for color accuracy of display panel.

Thus, on one hand, the disclosure can reuse a large amount of pixel data at multiple positions of multiple frames of images through the first memory during the frame by frame display compensation correction process, greatly reducing the demand for hardware storage resources and eliminating the demands for repeated calculation and storing of pixel data. On the other hand, it can reuse hardware resources such as the weighted sum circuit, the mean calculation circuit, the filtering circuit, and the mapping circuit for pixel position relationship together with the optical correction to reduce the software processing load during the display compensation correction process, thereby further improving the image display quality of XR display devices based on limited software and hardware resources.

Furthermore, as shown in FIG. 1, in some embodiments of the disclosure, the extended reality display device can further include a camera 16. Herein, the camera 16 is selected from at least one of a binocular fisheye camera, a monochrome IR camera, a structured light depth sensing camera, and a laser ToF depth sensing camera, and is connected to the coprocessor 14 via an image signal processing (ISP) module. The display pipeline configured in the coprocessor 14 can also obtain a real scene image to be processed through the camera 16, and use a locally configured layer mixing unit (i.e. a third software), and at least one hardware image processing unit such as the first memory, the weighted sum circuit, the mean calculation circuit, the filtering circuit, and the mapping circuit for pixel position relationship, to perform layer mixing on the virtual rendering image that has undergone the optical correction and the real scene image, according to the eye movement signal and the motion perception information, to obtain a mixed reality image. Herein, the real scene image can be a real scene image that has undergone the optical correction by the ISP module, or it can be an original real scene image that has not undergone the optical correction. Afterwards, the display pipeline can use the software processing unit and the at least one hardware image processing unit to perform the above-mentioned display compensation correction on the mixed reality image according to the obtained eye movement signal and the motion perception information.

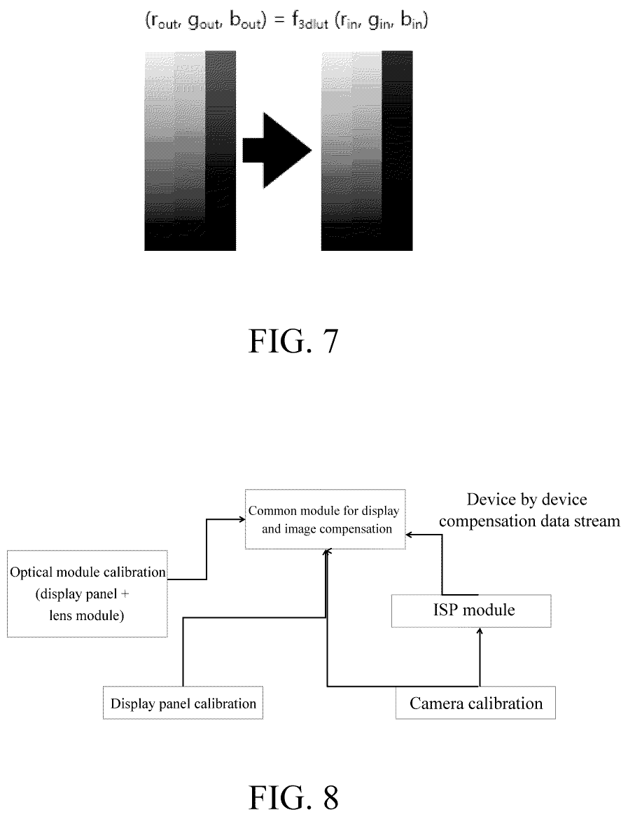

Furthermore, in some embodiments of the disclosure, the at least one hardware image processing unit can further include a second memory. This second memory is used to store calibration data of an optical module (such as lens modules), a display panel, and/or a camera. As shown in FIG. 8, during the process of performing the optical correction on the virtual rendering image, the display pipeline can also obtain the calibration data of each device one by one from the second memory, and use the above optical correction unit (i.e. the first software), combined with the at least one hardware image processing unit such as the first memory, the weighted sum circuit, the mean calculation circuit, the filtering circuit, the mapping circuit for pixel position relationship, etc., to perform lens optical correction on the virtual rendering image according to the calibration data. In addition, during the process of performing the display compensation correction on the virtual rendering image, the display pipeline can also obtain the calibration data of each device one by one from the second memory, use the above display compensation correction unit (i.e. the second software), and combined with the at least one hardware image processing unit such as the first memory, the weighted sum circuit, the mean calculation circuit, the filtering circuit, and the mapping circuit for pixel position relationship to perform screen display compensation correction on the virtual rendering image according to the calibration data. In this way, the disclosure can further improve the image display quality of XR display devices based on limited software and hardware resources.

In addition, during the process of performing the display compensation correction on the mixed reality image, the display pipeline can also obtain interaction information such as occlusion information and transparency of related layers between the real scene image and the virtual rendering image from the graphics processing unit (GPU) of the main processor 13. Afterwards, the display pipeline can use the above layer mixing unit (i.e. the third software) according to the eye movement signal, the motion perception information, and the interaction information, and combined with the at least one hardware image processing unit such as the first memory, the weighted sum circuit, the mean calculation circuit, the filtering circuit, and the mapping circuit for pixel position relationship to perform the layer mixing on the virtual rendering image that has undergone the optical correction and the real scene image. Then, the above display compensation correction unit (i.e. the second software) and the at least one hardware image processing unit such as the first memory, the weighted sum circuit, the mean calculation circuit, the filtering circuit, and the mapping circuit for pixel position relationship can be used to perform the display compensation correction on the mixed reality image obtained by mixing. The specific scheme of performing the display compensation correction on the mixed reality image is similar to the above embodiments and will not be repeated here.

In addition, in some embodiments of the disclosure, the display pipeline can further configure a color enhancement unit (i.e. a forth software). In the process of performing the image processing, the display pipeline can also use the color enhancement unit (i.e. the forth software) and combined with the at least one hardware image processing unit, such as the first memory, the weighted sum circuit, the mean calculation circuit, the filtering circuit, the mapping circuit for pixel position relationship, etc., according to the obtained eye movement signal and the motion perception information, to enhance the color of the virtual rendering image that has undergone the optical correction or the mixed reality image, and then use the display compensation correction unit (i.e. the second software) and the at least one hardware image processing unit, such as the first memory, the weighted sum circuit, the mean calculation circuit, the filtering circuit, the mapping circuit for pixel position relationship, etc., to perform the display compensation correction on the obtained color enhanced image, according to the eye movement signal and the motion perception information. The specific scheme of performing the display compensation correction on the color enhanced image is similar to the above embodiments and will not be repeated here.

In addition, in some embodiments of the disclosure, the display pipeline can further configure a spatial distortion correction unit (i.e. a fifth software). During the process of performing the image processing, the display pipeline can also use the spatial distortion correction unit (i.e. the fifth software) and combined with the at least one hardware image processing unit such as the first memory, the weighted sum circuit, the mean calculation circuit, the filtering circuit, and the mapping circuit for pixel position relationship to perform spatial distortion correction on the virtual rendering image, according to the obtained eye movement signal.

In one embodiment, during the process of performing the spatial distortion correction, in response to obtaining the virtual rendering image to be processed, the spatial distortion correction unit (i.e. the fifth software) can firstly determine the pixel data and processing parameters required for the spatial distortion correction. In some embodiments, the pixel data can be determined according to the eye movement signal of the user. Afterwards, the spatial distortion correction unit (i.e. the fifth software) can obtain processing parameters from each corresponding memory, and obtain pixel cache data required for the image distortion correction processing from each corresponding first memory. Then, the processing parameters and the pixel cache data are sequentially input into one or more of the weighted sum circuit, the mean calculation circuit, the filtering circuit, and the mapping circuit for pixel position relationship mentioned above, preforming weighted sum, mean calculation, filtering, and/or pixel position mapping hardening calculation to obtain the corresponding hardening calculation result. Afterwards, the spatial distortion correction unit (i.e. the fifth software) can obtain image that have undergone the distortion correction through software operations such as data arrangement and assignment, thereby further improving the image display quality of XR display devices based on limited software and hardware resources.

In addition, in some embodiments of the disclosure, the display pipeline can further configure a composite compression unit (i.e. a sixth software). In the process of performing the image processing, the display pipeline can also use the composite compression unit (i.e. the sixth software) and combined with the at least one hardware image processing unit such as the first memory, the weighted sum circuit, the mean calculation circuit, the filtering circuit, and the mapping circuit for pixel position relationship to perform composite compression processing on the virtual rendering image, according to the obtained eye movement signal.

In one embodiment, the composite compression can be divided into two parts of upsampling process and downsampling process. During the downsampling process, in response to obtaining the compression parameters associated with the eye movement signal of the user and the virtual rendering image to be processed from the aforementioned display driver software and/or firmware computing platform, the composite compression unit (i.e. the sixth software) can firstly divide the virtual rendering image into multiple partitions according to the gaze point position of the user according to the compression parameters of the updated compression model, and determine coordinate range of each partition and the downsampling magnification of each non attention partition far from the gaze point position. Afterwards, the composite compression unit (i.e. the sixth software) can retrieve the processing parameters for downsampling operations from the corresponding memory based on the coordinates of each pixel in each partition, and obtain the pixel cache data required for downsampling processing from the corresponding first memory. Afterwards, the composite compression unit (i.e. the sixth software) can sequentially input the obtained processing parameters and pixel cache data of each pixel into one or more of the weighted summation circuit, the mean calculation circuit, the filtering circuit, and the mapping circuit for pixel position relationship mentioned above, and perform the weighted sum, the mean calculation, the filtering, and/or the pixel position mapping hardening calculation on the pixel cache data to obtain a first hardening calculation result based on downsampling processing. Afterwards, the composite compression unit (i.e. the sixth software) can obtain the downsampled compressed image through software operations such as data arrangement and assignment.

In addition, during the upsampling process, in response to obtaining the compression parameters associated with the eye movement signal of the user and the virtual rendering image to be processed, the composite compression unit (i.e. the sixth software) can also determine the upsampling magnification of each attention zone containing/near the gaze point position based on the updated compression parameters of the compression model. Afterwards, the composite compression unit (i.e. the sixth software) can retrieve the processing parameters for upsampling operations from the corresponding memory based on the coordinates of each pixel in each partition, and obtain the pixel cache data required for upsampling processing from the corresponding first memory. Herein, the pixel cache data includes but not limited to the cache data of at least one nearby pixel in the current frame, as well as the cache data of these nearby pixels in at least one historical frame before them. Afterwards, the composite compression unit (i.e. the sixth software) can sequentially input the obtained processing parameters and pixel cache data of each pixel into one or more of the weighted summation circuit, the mean calculation circuit, the filtering circuit, and the mapping circuit for pixel position relationship mentioned above, and perform the weighted sum, the mean calculation, the filtering, and/or the pixel position mapping hardening calculation on the pixel cache data to obtain a second hardening calculation result based on super-resolution processing.

Afterwards, the composite compression unit (i.e. the sixth software) can summarize the second hardening calculation result and the first hardening calculation result mentioned above, and perform software operations such as data arrangement and assignment to obtain an equivalent resolution of 40 pixels per degree for 4K display in attention partition containing or near the gaze point position, and compress the re compressed image by downsampling at least one non attention partition far from the gaze point position. Thus, the disclosure can further enhance the equivalent resolution and real-time performance of XR display devices based on limited software and hardware resources.

In summary, compared to the existing technology of using hardware modules to implement the display compensation correction on the screen side display driver chip (DDIC) and software to implement the optical compensation on the graphics processor (GPU), the disclosure combines the eye movement signal and the motion perception information of the user in the display pipeline of the image processor 14 for the optical correction and the display compensation correction, and improves data storage, processing, and transmission efficiency by setting and reusing hardware image processing units, thereby enhancing the image display quality of XR display devices based on limited software and hardware resources. In addition, the disclosure also targets combination of Micro OLED display devices and pancake lens optical devices for XR display devices, as well as combination of LCD displays and pancake lens optical devices for 0D/1D/2D backlight modules, introducing various compensation algorithms such as the distortion removal, the uniformity correction, the color separation removal, and/or the color accuracy compensation correction, providing a convenient solution for new generation of VR head mounted display devices with Micro OLED+pancake lens and LCD+pancake lens as display optical solutions.

In addition, after obtaining the corrected image that has undergone the optical correction and the display compensation correction through the coprocessor 14, the coprocessor 14 can also transmit the corrected image to the display terminal 15 for high quality display of augmented reality images.

The system architecture of the extended reality display device using coprocessor 14 described above is only a non-limiting embodiment provided by the disclosure, aiming to clearly demonstrate the main concept of the disclosure and provide a specific solution for public implementation, rather than limiting the scope of protection of the disclosure.

In other embodiments, the image processor provided in one embodiment of the disclosure can also be integrated into the main processor units such as the central processing unit (CPU) and the graphics processing unit (GPU) of the extended reality display device provided in one embodiment of the disclosure in the form of software programs and hardware units to achieve the same effects, and will not be repeated here.

In addition, for the high-resolution display remands in the extended reality (XR) field, the display resolution of existing XR devices generally cannot meet the resolution required for 4K display. When the resolution of gaze range of a human eye is less than 40 pixels per degree, a user will clearly see the pixels and their boundaries, thereby affecting the display effect. In response to the demand for improving display resolution, this field has proposed some improved techniques for multi-screen overlay or nested output of multiple images. However, based on these improved technologies, the solution of using mechanical structures to manipulate multiple screens to achieve high-definition gaze point rendering has drawbacks of high hardware complexity and occupying a large volume. The solution of using nested transmission of multiple images for gaze point compression will produce obvious jagged edges and flickering phenomena at a boundary between high definition and low-definition images, which will also affect the display effect.

In order to overcome the above-mentioned shortcomings of the existing technology, the disclosure also provides the image processor, the image processing method, the computer-readable storage medium, and the extended reality display device, which can also provide compression processing function for high-resolution display of local regions according to the eye movement signal of the user, and improve the storage, processing, and transmission efficiency of data by setting and reusing hardware image processing unit, thereby meeting high-resolution display remand of XR display devices based on limited software and hardware resources.

The working principle of the above image processor and the extended reality display device will be described below in conjunction with some embodiments of some image processing methods. In some non-limiting embodiments, the extended reality display device can use a system architecture of a coprocessor. The embodiments of these image processing methods only provide some non-limiting implementations of the disclosure, which is intended to clearly display the main idea of the disclosure, and provide some specific proposals that are convenient for the public to implement, rather than limiting all working manners or all functions of the image processing system and the extended reality display device. Similarly, the image processor and the extended reality display device is also only a non-limiting embodiment provided by the disclosure, and does not limit the implementation subject to each step in these image processing methods.

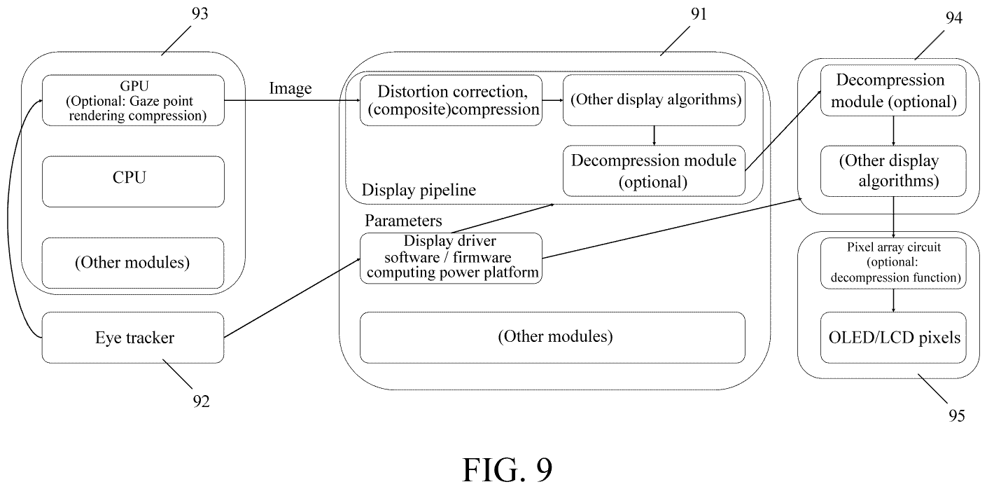

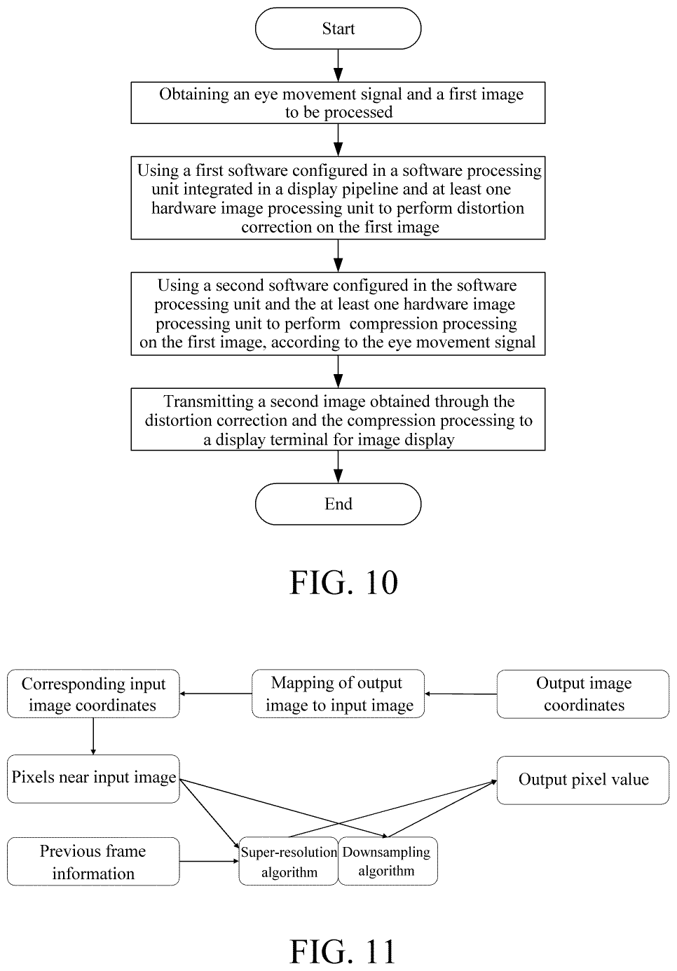

Please refer to FIG. 9 to FIG. 11. FIG. 9 shows a schematic diagram of the extended reality display device provided according to some embodiments of the disclosure. FIG. 10 shows a flowchart of the image processing method provided according to some embodiments of the disclosure. FIG. 11 shows a flowchart of the composite compressed image provided according to some embodiments of the disclosure.

As shown in FIG. 9, in some embodiments of the disclosure, the extended reality display device can be configured with a coprocessor 91, an eye tracker 92, a main processor 93, a display driver chip 94 and a display terminal 95. Furthermore, the coprocessor 91 can use the image processor provided according to the disclosure, and is configured with a display pipeline. The display pipeline integrates a software processing unit and at least one hardware image processing unit, and is configured to use different software programs and the same hardware image processing unit to perform image processing processes such as image distortion correction, image compression, thereby improving the storage, processing, and transmission efficiency of data, thereby enhancing the image display quality of XR display devices based on limited software and hardware resources. The eye tracker 92 is used to collect an eye movement signal of a user such as gaze position and gaze direction. The main processor 93 is selected from common image processors such as a central processing unit (CPU) and a graphics processing unit (GPU), and is used to output a first image to be processed by the coprocessor 91. The display driver chip 94 can be integrated in the display terminal 95 to obtain the second image that has undergone processed by the coprocessor 91, and display the image through the pixel array circuit and OLED/LED pixel array configured in the display terminal 95.

In one embodiment, the software processing unit configured in the display pipeline of coprocessor 91 include but not limited to distortion correction unit and/or image compression unit. The hardware image processing unit configured in the display pipeline can be selected from at least one of a transistor level cache memory, a weighted summation circuit, a mean calculation circuit, a filtering circuit, and a mapping circuit for pixel position relationship, used to store multiple pixel data in the current frame and/or previous historical frames of the first image, and/or perform hardening calculation of weighted summation, mean calculation, filtering, and/or pixel position mapping on these pixel data.

As shown in FIG. 10, during the process of image processing, the display pipeline can firstly obtain an eye movement signal and a first image to be processed. Herein, the eye movement signal includes but not limited to eye deviation angle, gaze position, gaze direction, and other data of the user. The display pipeline can be directly connected to the eye tracker 92 and obtain the eye movement signal directly from the eye tracker 92, or indirectly connected to the eye tracker 92 through the GPU or other image processing units of the main processor 93, and indirectly synchronously obtain the eye movement signal of the user through the main processor 93. In addition, for the embodiment of mixed reality (MR) display, the first image can be the original virtual rendering image generated by the GPU or other image processing units of the main processor 93.

Furthermore, in some preferred embodiments, the main processor 93 can also be connected to the eye tracker 92, configured to obtain the eye movement signal of the user from the eye tracker 92, and firstly perform gaze point rendering compression on the generated original virtual rendering image according to the eye movement signals, and then send the compressed gaze point rendering image to the coprocessor 91 to reduce the data transmission and processing load of the entire architecture.

As shown in FIGS. 9 and 10, after obtaining the first image and the eye movement signal of the user, the display pipeline can use the image distortion correction unit (i.e. the fifth software) configured therein, and the at least one hardware image processing unit integrated therein, to perform image distortion correction on the obtained first image.

In one embodiment, in response to obtaining the first image to be processed, the image distortion correction unit (i.e. the fifth software) can firstly determine the pixel data and processing parameters required for image distortion correction. In some embodiments, the pixel data can be determined according to the eye movement signal of the user.

Afterwards, the image distortion correction unit (i.e. the fifth software) can obtain processing parameters from each corresponding memory, and obtain pixel cache data required for the image distortion correction from each corresponding cache memory. Then, the processing parameters and pixel cache data are sequentially input into one or more of the weighted sum circuit, the mean calculation circuit, the filtering circuit, and mapping circuit for pixel position relationship mentioned above, preforming the weighted sum, the mean calculation, filtering, and/or the pixel position mapping hardening calculation to obtain the corresponding hardening calculation results. Afterwards, the image distortion correction unit (i.e. the fifth software) can obtain image that have undergone distortion correction through software operations such as data arrangement and assignment.

Furthermore, in some embodiments shown as FIG. 9, the coprocessor 91 can also be configured with display driver software and/or firmware computing power platform. The display driver software and/or the firmware computing platform are respectively connected to the eye tracker 92 and the display pipeline. During the process of preforming compression on the first image, the coprocessor 91 can firstly obtain the eye movement signal of the user from the eye tracker 92 through the display driver software and/or the firmware computing platform, and perform eye tracking calculation to determine the gaze point position. Afterwards, the display driver software and/or the firmware computing platform can update the internal gaze point information of the system according to the gaze point position to construct an updated compression model, and transmit compression parameters of the updated compression model to the display pipeline, for performing compression on the first image.

As shown in FIG. 10 and FIG. 11, in response to obtaining the first image and the eye movement signal (or the compression parameters associated with the eye movement signal of the user), the display pipeline can use configured the image compression unit (i.e. the sixth software) and the at least one integrated hardware image processing unit to compress the first image according to the eye movement signal.

In one embodiment, in response to obtaining the compression parameters associated with the eye movement signal of the user and the first image to be processed, the image compression unit (i.e. the sixth software) can firstly divide the first image into multiple partitions based on the gaze point position of the user according to the updated compression parameters of the compression model, and determine the coordinate range of each partition and the downsampling magnification of each non attention partition far from the gaze point position. Afterwards, the image compression unit (i.e. the sixth software) can retrieve the processing parameters for downsampling operations from the corresponding memory based on the coordinates of each pixel in each partition, and obtain the pixel cache data required for downsampling processing from the corresponding cache memory. Afterwards, the image compression unit (i.e. the sixth software) can sequentially input the obtained processing parameters and pixel cache data of each pixel into one or more of the weighted sum circuit, the mean calculation circuit, the filtering circuit, and the mapping circuit for pixel position relationship mentioned above, and perform the weighted sum, the mean calculation, the filtering, and/or the pixel position mapping hardening calculation on these pixel cache data to obtain a first hardening calculation result based on downsampling processing. Afterwards, the image compression unit (i.e. the sixth software) can obtain downsampled compressed image through software operations such as data arrangement and assignment.

In addition, in some embodiments of the disclosure, a super-resolution unit (i.e. the seventh software) can be configured in the display pipeline of the coprocessor 91, to perform composite compression processing on the first image together with the image compression unit (i.e. the sixth software).

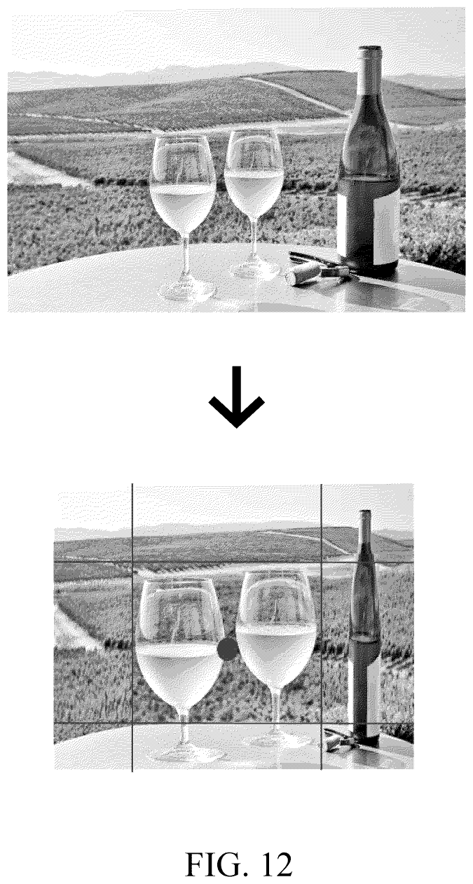

In one embodiment, during the process of preforming composite compression on the first image, in response to obtaining the compression parameters associated with the eye movement signal of the user and the first image to be processed, the super-resolution unit (i.e. the seventh software) can firstly divide the first image into multiple partitions based on the gaze point position of the user according to the updated compression parameters of the compression model, and determine the coordinate range of each partition, and the upsampling magnification of each attention partition containing adjacent gaze point positions. Afterwards, the super-resolution unit (i.e. the seventh software) can retrieve the processing parameters for downsampling operations from the corresponding memory based on the coordinates of each pixel in each partition, and obtain the pixel cache data required for super-resolution processing from the corresponding cache memory. Herein, the pixel cache data includes but not limited to the cache data of at least one nearby pixel in the current frame, as well as the cache data of these nearby pixels in at least one historical frame before them. Afterwards, the super-resolution unit (i.e. the seventh software) can sequentially input the obtained processing parameters and pixel cache data of each pixel into one or more of the weighted sum circuit, the mean calculation circuit, the filtering circuit, and the mapping circuit for pixel position relationship mentioned above, and perform the weighted sum, the mean calculation, the filtering, and/or the pixel position mapping hardening calculation on these pixel cache data to obtain the second hardening calculation result based on super-resolution processing. Afterwards, the super-resolution unit (i.e. the seventh software) can summarize the second hardening calculation result and the first hardening calculation result mentioned above, and obtain the compressed image as shown in FIG. 12 through software operations such as data arrangement and assignment.

As shown in FIG. 12, after the eye movement based composite compression processing, at least one attention partition containing adjacent gaze point positions in the first image is super-resolution processed based on same and/or different upsampling magnification, thereby achieving an equivalent resolution of 40 pixels per degree for 4K display in these attention partitions. At the same time, at least one non attention partition far from the gaze point position in the first image is compressed based on same and/or different downsampling magnifications, thereby reducing data processing load and/or data transmission load of these non-attention partitions.

Compared to pure software solutions that require distortion correction and image compression by calculating and storing pixel data for each relevant pixel frame by frame and partition by partition, the disclosure effectively improves the reuse rate of pixel cache data for each frame and partition, and effectively reduces the data processing load of software units by designing and reusing the cache memory, the weighted sum circuit, the mean calculation circuit, the filtering circuit, and the mapping circuit for pixel position relationship, thereby the overall data processing and transmission load of coprocessor 91 is reduced, which facilitates the coprocessor 91 to meet the high resolution display requirements of XR display devices based on limited software and hardware resources.

As shown in FIG. 10, after obtaining the second image that has undergone the distortion correction and the compression processing by coprocessor 91, coprocessor 91 can transmit the second image to the display terminal 95 for high resolution display of the extended reality image.

In one embodiment, for the embodiment where the main processor 93 sends the first image after gaze point rendering compression to the coprocessor 91, the display pipeline of the coprocessor 91 can also integrate a decompression module. The abovementioned display driver software and/or the firmware computing power platform is connected to the decompression module. The software processing unit and the at least one hardware image processing unit configured in the display pipeline are also connected to the display terminal 95 through the decompression module. In this way, during the transmission of the second image to the display terminal 95, the decompression module configured in the coprocessor 91 can firstly obtain the second image that has undergone the distortion correction and the compression through the software processing unit and the at least one hardware image processing unit integrated in the display pipeline, and then obtain the compression parameters of the updated compression model through the display driver software and/or the firmware computing power platform, thereby performing decompression on the second image that has undergone the distortion correction and the compression to obtain the third image, according to the compression parameters of the updated compression model. Afterwards, the coprocessor 91 can transmit the decompressed third image to the display terminal 95 for high resolution display of the extended reality image.

Furthermore, for the embodiment that the main processor 93 sends the first image after gaze point rendering compression to the coprocessor 91, the abovementioned decompression module can also be configured on the display terminal 95 or its display driver chip 94. Taking the decompression module configured on the display driver chip 94 as an example, the decompression module can be respectively connected to the display pipeline, the display driver software, and/or the firmware computing power platform of the coprocessor 91. During the process of transmitting the second image to the display terminal 95, the decompression module configured on the display driver chip 94 can firstly obtain the second image that has undergone the distortion correction and the compression through the software processing unit and the at least one hardware image processing unit integrated in the display pipeline, then the eye movement signal, the gaze point position of the user, and/or the updated compression model compression parameters can be obtained through the above display driver software and/or the firmware computing power platform, thereby performing decompression on the second image that has undergone the distortion correction and the compression to obtain the third image, according to the eye movement signal, the gaze point position, and/or the updated compression model compression parameters. Afterwards, the display driver chip 94 can directly drive the pixel array circuit of the OLED display screen or the LED display screen and other display terminals 95 according to the decompressed third image, for performing high resolution display of the extended reality image on the display terminal 95.

Furthermore, in some embodiments, the abovementioned decompression module can also be more optimally configured in the pixel array circuit of the display terminal 95. In this way, the image data transmitted throughout the entire architecture of the extended reality display device is compressed through the gaze point rendering, which can further reduce the data transmission and processing load of the entire architecture. The working principle of the decompression module of the pixel array circuit configured in the display terminal 95 is similar to the embodiment configured in the display driver chip 94 described above, and will not be repeated here.

The system architecture of the extended reality display device using coprocessor 91 described above only provide some non-limiting implementations of the present disclosure, which is intended to clearly display the main idea of the present disclosure, and provide some specific proposals that are convenient for the public to implement, the scope of protection of the present disclosure.

In other embodiments, the image processor provided by the present disclosure can also be integrated into the main processor units such as the central processing unit (CPU) and the graphics processing unit (GPU) of the extended reality display device provided by the present disclosure in the form of software programs and hardware units, in order to achieve the same effects, which will not be repeated here.

In addition, for the high-resolution display remands in the XR field, existing XR devices generally perform super-resolution processing on multiple different regions in low definition images at different scales, and then concatenate and nest the various regions to improve the equivalent resolution of some regions in low definition images. However, this conventional super-resolution technology is currently mainly based on artificial intelligence (AI) model training of natural image samples, and is mainly implemented for still images or mobile videos. On one hand, it does not pursue low latency and hardware feasibility, and on the other hand, it does not combine with actual application scenarios of XR display, and cannot provide accurate and efficient super-resolution processing for the gaze area the user.

In order to overcome the above-mentioned shortcomings of existing technologies, the disclosure provides an image processor, an image processing method, a computer-readable storage medium, and an extended reality display device that can also determine a gaze area according to the eye movement signal of the user and perform targeted super-resolution processing on the gaze area, thereby meeting the high resolution display remands for the gaze area of the user and reducing the delay and hardware remands of the high resolution display.

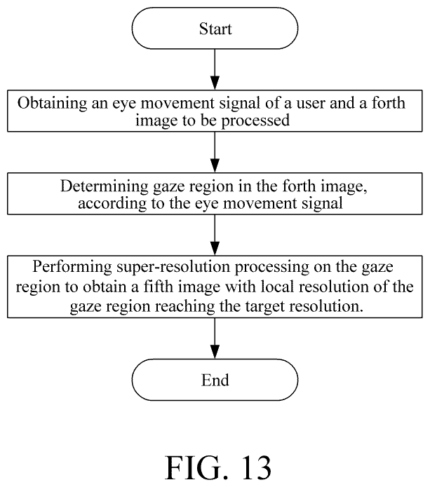

Please refer to FIG. 13, FIG. 13 shows a flowchart of the image processing method provided according to some embodiments of the disclosure.

As shown in FIG. 13, during the process of image processing, the image processor can firstly obtain an eye movement signal of a user and a low definition image to be processed (i.e. a fourth image), and determine at least one gaze region containing the position of the adjacent gaze point in the fourth image according to the eye movement signal.

In one embodiment, the fourth image can be an original virtual rendering image generated by an image processing unit such as GPU. The image processor can be connected to an external eye tracker to obtain the eye movement signal of the user collected by it. Afterwards, the image processor can perform eye tracking calculation according to the eye movement signal obtained from the eye tracker to determine the gaze point position of the user in the fourth image, and update gaze point information according to the gaze point position to construct an updated compression model. Afterwards, the image processor can divide the fourth image into multiple partitions regarding the gaze point position according to compression parameters of the updated compression model, and determine the coordinate range of each partition separately. Herein, the multiple partitions regarding gaze point positions should include at least one gaze region containing adjacent gaze point positions, and can include at least one non-gaze region far from the gaze point positions. The compression model can use an artificial intelligence model trained on a large number of super-resolution processed image samples based on XR display devices, and its details will be described later.

Please continue to refer to FIG. 13, after determining the at least one gaze region, the image processor can perform local super-resolution processing on each pixel in the gaze region according to the coordinate range of the gaze region, to obtain a high definition image (i.e. the fifth image) with the local resolution of the gaze area reaching the target resolution (e.g. 40 pixels/degree).

In one embodiment, during the process of performing super-resolution processing, the image processor can firstly determine the upsampling magnification of the at least one gaze region containing and/or adjacent to the gaze point position according to the compression parameters of the updated compression model, then performing corresponding super-resolution processing on each gaze region in the fourth image, to obtain the fifth image with the local resolution reaching the target resolution, according to on the coordinate range and upsampling magnification of the each gaze region. In one embodiment, each gaze region containing and/or adjacent to the gaze point position can have the same and/or different upsampling magnifications according to its distance from the gaze point position, to achieve a display effect of gradually increasing resolution towards the gaze point position.

Furthermore, for the at least one non-gaze region far from the gaze point mentioned above, the image processor can also perform compression processing to obtain a fifth image where the local resolution of the gaze region reaches the target resolution and the local resolution of the non-gaze area is lower than the target resolution.

In one embodiment, during the process of compressing the non-gaze region, the image processor can firstly determine the downsampling magnification of the at least one non-gaze region far from the gaze point position according to the updated compression parameters of the compression model, preforming he corresponding magnification compression processing on each non-gaze region in the fourth image, to obtain a fifth image with a local resolution of the non-gaze region lower than the target resolution, according to the coordinate range and downsampling magnification of the each non-gaze area. In one embodiment, each non-gaze region far from the gaze point position can have the same and/or different downsampling magnifications according to its distance from the gaze point position, achieve a display effect that the resolution gradually decreases as it moves away from the gaze point position.

Furthermore, in some embodiments of the disclosure, during the process of image processing, in response to obtaining the fourth image to be processed, the image processor can firstly recognize a first resolution of the fourth image. In response to a recognition result that the first resolution is lower than the target resolution (e.g. 40 pixels/degree), the image processor can perform super-resolution processing on the gaze region of the fourth image to obtain the fifth image with a local resolution of the gaze region that reaches the target resolution. On the contrary, in response to a recognition result that the first resolution is higher than the target resolution (e.g. 40 pixels/degree), the image processor can perform compression on the non-gaze region of the fourth image to obtain the fifth image that a local resolution of the gaze region that reaches the target resolution, and the local resolution of the non-gaze region is lower than the target resolution.

In one embodiment, the abovementioned compression model can be composed of a feature extraction model and multiple candidate convolutional neural network models. During the process of image processing, the image processor can firstly extract an image feature from the fourth image through a pretrained feature extraction model. Afterwards, in response to the recognition result that the first resolution of the fourth image is lower than the target resolution (e.g. 40 pixels/degree), the image processor can select an upsampling convolution kernel corresponding to the upsampling magnification and/or the pixel mapping relationship according to the extracted image feature, and perform corresponding super-resolution processing on the each gaze region of the fourth image according to the coordinate range, the upsampling magnification, and the upsampling convolution kernel of the each gaze region, to obtain the fifth image with a local resolution of the gaze area that reaches the target resolution, thereby preserving the image feature as much as possible. On the contrary, in response to the recognition result of the first resolution higher than the target resolution (e.g. 40 pixels/degree), the image processor can select a downsampling convolution kernel corresponding to the downsampling magnification and/or the pixel mapping relationship according to the extracted image feature, and perform corresponding low-pass filtering and compression processing on the each non-gaze region of the fourth image according to the coordinate, the downsampling magnification, and the downsampling convolution kernel of the each non-gaze region, to obtain the fifth image with a local resolution of the gaze region that reaches the target resolution and a local resolution of the non-gaze region that is lower than the target resolution, thereby avoiding image blur and aliasing.

By using the pretrained feature extraction model to extract the image feature, and then selecting a corresponding convolution kernel for image composite compression processing (i.e. upsampling and downsampling) according to the extracted image feature, the disclosure can effectively preserve the image feature in the fourth image and avoid image blurring and aliasing.

As shown in FIG. 12, compared to the conventional super-resolution technology of existing XR devices, the disclosure determines the gaze region according to the eye movement signal of the user and performs targeted super-resolution processing on the gaze region, thus more accurately meeting the high resolution display remands of the user for the gaze region. In addition, by performing local super-resolution processing on the gaze region, the disclosure can eliminate the super-resolution processing operation on the remaining non-gaze region, reduce the upsampling magnification for the non-gaze region, or perform downsampling compression processing on the non-gaze region, thereby reducing the delay of high resolution display and the hardware remands for the image processor.

In addition, in some embodiments of the disclosure, the image processor can also be configured with a display pipeline. The display pipeline integrates a software processing unit and at least one hardware image processing unit, and is configured to use the software processing unit and the at least one hardware image processing unit to perform (composite) compression processing on the fourth image, to obtain the fifth image that meets the high resolution display remands of the user for the gaze region and reduces the delay and hardware remands of high resolution display.

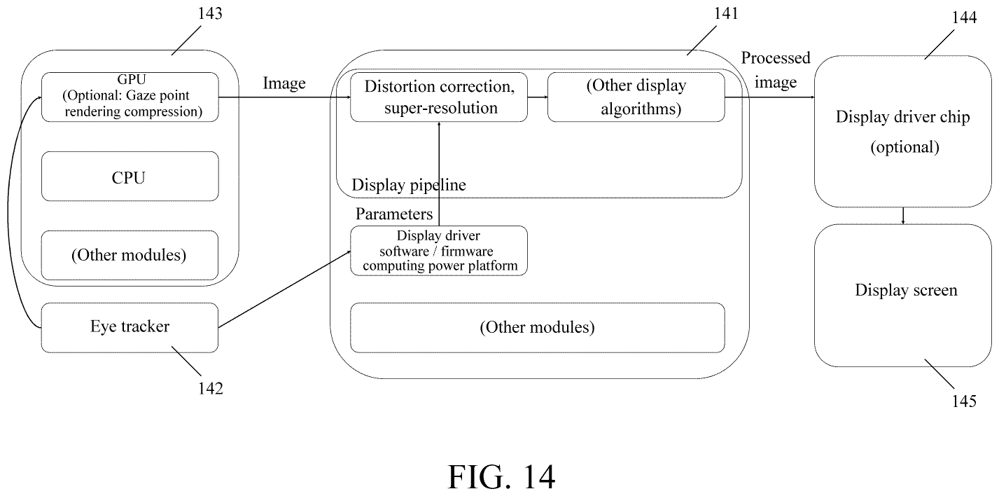

Please refer to FIG. 14 for details. FIG. 14 shows a schematic diagram of the extended reality display device provided according to some embodiments of the disclosure.

In the embodiment shown as FIG. 14, the extended reality display device provided by the disclosure can be configured with a coprocessor 141, an eye tracker 142, a main processor 143, a display driver chip 144, and a display terminal 145. The coprocessor 141 can use the image processor provided by the disclosure, and is configured with a display pipeline. The display pipeline integrates a software processing unit and at least one hardware image processing unit, and is configured to use different software programs and the same hardware image processing unit to perform image processing processes such as super-resolution and compression, thereby improving the storage, processing, and transmission efficiency of data, thereby meeting the high resolution display remands of the user for the gaze region and reduces the delay and hardware requirements of high resolution display for the fifth image based on limited software and hardware resources.

The eye tracker 142 is used to collect the eye movement signal such as gaze position and the gaze direction of the user. The main processor 143 is selected from common image processors such as central processing unit (CPU) and graphics processing unit (GPU), and is used to output a fourth image to be processed by the coprocessor 141. The display driver chip 144 can be integrated into the display terminal 145 to obtain the fifth image processed by the coprocessor 141, and display the image through the pixel array circuit and OLED/LED/LCD pixel array configured in the display terminal 145.

In one embodiment, the software processing unit configured in the display pipeline of coprocessor 141 include but not limited to upsampling unit and/or downsampling unit. The hardware image processing unit configured in the display pipeline can be selected from at least one of a transistor level cache memory, a weighted sum circuit, a mean calculation circuit, a filtering circuit, and a mapping circuit for pixel position relationship, used to store multiple pixel cache data in the current frame and/or previous historical frames of the fourth image, and/or hardening calculation of perform weighted sum, mean calculation, filtering, and/or pixel position mapping on these pixel cache data.

During the process of image processing, the display pipeline can firstly obtain the eye movement signal of the user and the fourth image to be processed. Herein, the eye movement signal includes but not limited to eye deviation angle, gaze position, gaze direction, and other data of the user. The display pipeline can be directly connected to the eye tracker 142 and obtain the eye movement signal directly from the eye tracker 142, or indirectly connected to the eye tracker 142 through the GPU or other image processing units of the main processor 143, and indirectly synchronously obtain the eye movement signal of the user through the main processor 143. In addition, for the implementation of mixed reality (MR) display, the fourth image can be the original virtual rendering image generated by the GPU or other image processing units of the main processor 143.

Furthermore, in some embodiments, the main processor 143 can also be connected to the eye tracker 142, configured to obtain the eye movement signal of the user from the eye tracker 142, and firstly perform gaze point rendering compression on the generated original virtual rendering image according to the eye movement signal, and then send the compressed gaze point rendering image to the coprocessor 141 to reduce the data transmission and processing load of the entire architecture.

Furthermore, in some embodiments shown as FIG. 14, the coprocessor 141 can also be configured with display driver software and/or firmware computing power platform. The display driver software and/or the firmware computing platform are respectively connected to the eye tracker 142 and the display pipeline. During the process of performing super-resolution on the fourth image, the coprocessor 141 can firstly obtain the eye movement signal of the user from the eye tracker 142 through the display driver software and/or the firmware computing power platform, and perform eye tracking calculation to determine the gaze point position. Afterwards, the display driver software and/or the firmware computing power platform can update the internal gaze point information of the system according to the gaze point position to construct an updated compression model, and transmit compression parameters of the updated compression model to the display pipeline, for performing super-resolution processing on the fourth image.

In one embodiment, please refer to FIG. 11 to FIG. 14. In response to obtaining the fourth image and the eye movement signal (or the compression parameters associated with the eye movement signal of the user), the display pipeline can use the upsampling unit configured therein (i.e. the seventh software) and the at least one image processing hardware unit integrated therein to perform super-resolution processing on the fourth image according to the eye movement signal. In one embodiment, in response to obtaining the compression parameters associated with the eye movement signal of the user and the fourth image to be processed, the upsampling unit (i.e. the seventh software) can first divide the fourth image into multiple partitions based on the gaze point position of the user according to the updated compression parameters of the compression model, and determine the coordinate range of each partition and the upsampling magnification of each gaze region containing adjacent gaze point positions. Afterwards, the upsampling unit (i.e. the seventh software) can retrieve the processing parameters for upsampling operations from the corresponding memory based on the coordinates of each pixel in each partition, and obtain the pixel cache data required for super-resolution processing from the corresponding cache memory. Afterwards, the upsampling unit (i.e. the seventh software) can sequentially input the obtained processing parameters and pixel cache data of each pixel into one or more of the weighted sum circuit, the mean calculation circuit, the filtering circuit, and the mapping circuit for pixel position relationship mentioned above, and perform the weighted sum, the mean calculation, the filtering, and/or the pixel position mapping hardening calculation on these pixel cache data to obtain a first hardening calculation result based on upsampling processing. Afterwards, the upsampling unit (i.e. the seventh software) can obtain upsampled image through software operations such as data arrangement and assignment.

In addition, in some embodiments, a downsampling unit (i.e., sixth software) can also be configured in the display pipeline of the coprocessor 141, to perform composite compression processing on the fourth image together with the upsampling unit (i.e. seventh software). In one embodiment, during the process of preforming composite compression on the fourth image, in response to obtaining the compression parameters associated with the eye movement signal of the user and the fourth image to be processed, the downsampling unit (i.e., the sixth software) can firstly divide the fourth image into multiple partitions based on the gaze point position of the user according to the updated compression parameters of the compression model, and determine the coordinate range of each partition, and the downsampling magnification of each non-gaze region far from the gaze point position. Afterwards, the downsampling unit (i.e. the sixth software) can retrieve the processing parameters for downsampling operations from the corresponding memory based on the coordinates of each pixel in each partition, and obtain the pixel cache data required for super-resolution processing from the corresponding cache memory. Herein, the pixel cache data includes but not limited to the cache data of at least one nearby pixel in the current frame, as well as the cache data of these nearby pixels in at least one historical frame before them. Afterwards, the downsampling unit (i.e. the sixth software) can sequentially input the obtained processing parameters and pixel cache data of each pixel into one or more of the weighted sum circuit, the mean calculation circuit, the filtering circuit, and the mapping circuit for pixel position relationship mentioned above, and perform the weighted sum, the mean calculation, the filtering, and/or the pixel position mapping hardening calculation on these pixel cache data to obtain the second hardening calculation result based on compression. Afterwards, the downsampling unit (i.e. the sixth software) can summarize the second hardening calculation result and the first hardening calculation result mentioned above, and obtain the compressed image shown in FIG. 12 through software operations such as data arrangement and assignment.

As shown in FIG. 12, after the eye movement based composite compression processing, at least one gaze region containing adjacent gaze points in the fourth image is super-resolution processed based on the same and/or different upsampling magnifications, thereby achieving an equivalent resolution of 40 pixels per degree for 4K display in these attention zones. At the same time, at least one non-gaze region far from the gaze point position in the fourth image is compressed based on the same and/or different downsampling magnifications, thereby reducing the data processing load and/or data transmission load of these non-attention partitions.

In addition, in some embodiments of the disclosure, an image distortion correction unit (i.e. fifth software) can be configured in the display pipeline of the coprocessor 141 to cooperate with the at least one hardware image processing unit integrated in the display pipeline to perform distortion correction on the obtained fourth image. In one embodiment, in response to obtaining the fourth image to be processed, the image distortion correction unit (i.e. the fifth software) can first determine the pixel data and processing parameters required for image distortion correction. In some embodiments, these pixel data can be determined according to the eye movement signal of the user. Afterwards, the image distortion correction unit (i.e. the fifth software) can obtain processing parameters from each corresponding memory, and obtain the pixel cache data required for the image distortion correction from each corresponding cache memory. Then, the processing parameters and the pixel cache data are sequentially input into one or more of the weighted sum circuit, the mean calculation circuit, the filtering circuit, and the mapping circuit for pixel position relationship mentioned above., and perform the weighted summation, the mean calculation, the filtering, and/or the pixel position mapping hardening calculation on these pixel cache data to obtain a corresponding hardening calculation result. Afterwards, the image distortion correction unit (i.e. the fifth software) can obtain images that have undergone the distortion correction through software operations such as data arrangement and assignment.

Compared to pure software solutions that require distortion correction and image compression by calculating and storing pixel data for each relevant pixel frame by frame and partition by partition, the disclosure effectively improves the reuse rate of pixel cache data for each frame and partition, and effectively reduces the data processing load of software units by designing and reusing the cache memory, the weighted sum circuit, the mean calculation circuit, the filtering circuit, and the mapping circuit for pixel position relationship, thereby the overall data processing and transmission load of coprocessor 141 is reduced, which facilitates the coprocessor 141 to meet the high resolution display requirements of XR display devices based on limited software and hardware resource, and reduces the delay of high resolution display.

In addition, after obtaining the fifth image that has undergone the distortion correction and the composite compression by the coprocessor 141, the coprocessor 141 can also transmit the fifth image to the display terminal 145 for high resolution display of the extended reality images.

In one embodiment, for the embodiment where the main processor 143 sends the fourth image after gaze point rendering compression to the coprocessor 141, the display pipeline of the coprocessor 91 can also integrate a decompression module. The abovementioned display driver software and/or the firmware computing power platform is connected to the decompression module. The software processing unit and the at least one hardware image processing unit configured in the display pipeline are also connected to the display terminal 145 through the decompression module. In this way, during the transmission of the fifth image to the display terminal 145, the decompression module configured in the coprocessor 141 can firstly obtain the fifth image that has undergone the distortion correction and the compression through the software processing unit and the at least one hardware image processing unit integrated in the display pipeline, and then obtain the compression parameters of the updated compression model through the display driver software and/or the firmware computing power platform, thereby performing decompression on the fifth image that has undergone the distortion correction and the compression to obtain the sixth image, according to the compression parameters of the updated compression model. Afterwards, the coprocessor 141 can transmit the decompressed sixth image to the display terminal 145 for high resolution display of the extended reality image.

Furthermore, for the embodiment where the main processor 143 sends the fourth image after gaze point rendering compression to the coprocessor 141, the abovementioned decompression module can also be configured on the display terminal 145 or its driver chip 144. Taking the decompression module configured on the display driver chip 144 as an example, the decompression module can be respectively connected to the display pipeline, the display driver software, and/or the firmware computing power platform of the coprocessor 141. During the process of transmitting the fifth image to the display terminal 145, the decompression module configured on the display driver chip 144 can firstly obtain the fifth image that has undergone the distortion correction and the compression through the software processing unit and the at least one hardware image processing unit integrated in the display pipeline, then the eye movement signal, the gaze point position of the user, and/or the updated compression model compression parameters can be obtained through the above display driver software and/or the firmware computing power platform, thereby performing decompression on the fifth image that has undergone the distortion correction and the compression to obtain the sixth image according to the eye movement signal, the gaze point position, and/or the updated compression model compression parameters. Afterwards, the display driver chip 144 can directly drive the pixel array circuit of the OLED display screen or the LED display screen or the LCD display screen and other display terminals 145 according to the decompressed sixth image, for performing high resolution display of the extended reality images on the display terminal 145.

Furthermore, in some embodiments, the abovementioned decompression module can also be more optimally configured in the pixel array circuit of the display terminal 145. In this way, the image data transmitted throughout the entire architecture of the extended reality display device is rendered and compressed through the gaze point rendering, which can further reduce the data transmission load and data processing load of the entire architecture. The working principle of the decompression module of the pixel array circuit configured in the display terminal 145 is similar to the embodiment configured in the display driver chip 144 described above, and will not be repeated here.

The system architecture of the extended reality display device using coprocessor 141 described above is only a non-limiting embodiment provided by the disclosure, aiming to clearly demonstrate the main concept of the disclosure and provide a specific solution for public implementation, rather than limiting the scope of protection of the disclosure.

In other embodiments, the image processor provided by the disclosure can also be integrated into the main processor units such as the central processing unit (CPU) and graphics processing unit (GPU) of the extended reality display device provided by the disclosure in the form of software programs and hardware units to achieve the same technical effects, which will not be repeated here.

Although the above methods are illustrated and described as a series of actions in order to simplify the explanation, it should be understood and appreciated that these methods are not limited by the order of actions, because according to one or more embodiments, some actions can occur in different order and/or concurrently with other actions from the illustrations and descriptions herein or not illustrated and described herein.

In one embodiment, signals and data can be represented using any of a variety of different technologies and techniques. For example, the data, instructions, commands, information, signals, bits, symbols and chips cited throughout the above description may be represented by voltage, current, electromagnetic waves, magnetic fields or magnetic particles, optical fields or optical particles, or any combination thereof.

Various illustrative logic blocks, modules, circuits and algorithm steps described in combination with the embodiments disclosed herein can be implemented as electronic hardware, computer software or a combination of both. In order to clearly explain the interchangeability of hardware and software, various illustrative components, blocks, modules, circuits and steps are generally described above in the form of their functionality. Whether such functionality is implemented as hardware or software depends on the specific application and design constraints imposed on the overall system. Technicians can implement the described functionality in different ways for each specific application, but such implementation decisions should not be interpreted as leading to departure from the scope of the disclosure.

The various illustrative logic modules and circuits described in connection with the embodiments disclosed herein can be realized or executed by general-purpose processors, digital signal processors (DSPs), application specific integrated circuits (ASICs), field programmable gate arrays (FPGAs) or other programmable logic devices, discrete gate or transistor logic, discrete hardware components or any combination thereof designed to perform the functions described herein. The general processor can be a microprocessor, but in some embodiments, the processor can be any conventional processor, controller, microcontroller or state machine. The processor can also be implemented as a combination of computing devices, such as a combination of DSP and microprocessors, a plurality of microprocessors, one or more microprocessors cooperating with the DSP core or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor so that the processor can read information from, and write information to, the storage medium. In one embodiment, the storage medium may be integral to the processor. The processor and the storage medium may reside in an ASIC. The ASIC may reside in a user terminal. In some embodiments, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable the making or use of the disclosure. Various modifications to the disclosure and the universal principles defined herein can be applied to other variants without departing from the spirit or scope of the disclosure. Therefore, this disclosure is not intended to be limited to the examples and designs described herein, but should be granted the widest scope consistent with the principles and novel features disclosed herein.

1. An image processor, comprising a display pipeline, wherein the display pipeline integrates a software processing unit and at least one hardware image processing unit, and is configured to:
obtaining an eye movement signal and motion perception information of a user, and obtaining a virtual rendering image to be processed;
using a first software configured in the software processing unit and the at least one hardware image processing unit to perform optical correction on the virtual rendering image, according to the eye movement signal and the motion perception information; and
using a second software configured in the software processing unit and the at least one hardware image processing unit to perform display compensation correction on the virtual rendering image, according to the eye movement signal and the motion perception information.

2. The image processor according to claim 1, wherein the at least one hardware image processing unit comprises a first memory, the first memory is used to store pixel data at multiple positions of a current frame of the virtual rendering image to be processed, and/or pixel data at multiple positions of at least one historical frame of the virtual rendering image, steps to perform the optical correction and/or the display compensation correction on the virtual rendering image comprise:
obtaining the pixel data at multiple positions of the current frame of the virtual rendering image, and/or the pixel data at multiple positions of the at least one historical frame of the virtual rendering image from the first memory; and
using the first software to perform the optical correction on the virtual rendering image, and/or using the second software to perform the display compensation correction on the virtual rendering image, according to the eye movement signal, the motion perception information, and the pixel data at multiple positions of the current frame and/or the pixel data at multiple positions of the at least one historical frame.

3. The image processor according to claim 2, wherein at least one hardware image processing unit further comprises at least one hardening calculation circuit, and steps to perform the optical correction and/or the display compensation correction on the virtual rendering image further comprise:
using the first software and the at least one hardening calculation circuit to perform the optical correction on the virtual rendering image, according to the eye movement signal, the motion perception information, and the pixel data at multiple positions of the current frame of the virtual rendering image and/or the pixel data at multiple positions of the at least one historical frame of the virtual rendering image; and/or
using the second software and the at least one hardening calculation circuit to perform the display compensation correction on the current frame of the virtual rendering image, according to the eye movement signal, the motion perception information, and the pixel data at multiple positions of the current frame of the virtual rendering image and/or the pixel data at multiple positions of the at least one historical frame of the virtual rendering image.

4. The image processor according to claim 3, wherein the step of using the second software and the at least one hardening calculation circuit to perform the display compensation correction on the virtual rendering image, according to the eye movement signal, the motion perception information, and the pixel data at multiple positions of the current frame of the virtual rendering image and/or the pixel data at multiple positions of the at least one historical frame of the virtual rendering image comprises:
determining a target pixel point according to the eye movement signal and the motion perception information;
obtaining raw data of the target pixel point and at least one related pixel point from the first memory;
using the at least one hardening calculation circuit to perform hardening calculation on the raw data of the target pixel point and the at least one related pixel point; and
using the second software to perform the display compensation correction, including distortion correction, uniformity correction, color separation removal and/or color accuracy compensation, on the current frame of the virtual rendering image, according to a result of the hardening calculation.

5. The image processor according to claim 3, wherein the at least one hardware image processing unit further comprises a second memory, the second memory is used to store calibration data of an optical module, a display panel and/or a camera, wherein
steps to perform the optical correction on the virtual rendering image further comprises: obtaining the calibration data from the second memory, and using the first software and at the least one hardening calculation circuit to perform lens optical correction on the virtual rendering image according to the calibration data, and/or
steps to perform the display compensation correction on the virtual rendering image comprises: obtaining the calibration data from the second memory, and using the second software and the at least one hardening calculation circuit to perform screen display compensation correction on the virtual rendering image according to the calibration data.

6. The image processor according to claim 1, wherein steps to perform the display compensation correction on the virtual rendering image comprise:
obtaining a real scene image to be processed;
using a third software configured in the software processing unit and the at least one hardware image processing unit, to perform layer mixing on the virtual rendering image that has undergone the optical correction and the real scene image, according to the eye movement signal and the motion perception information, to obtain a mixed reality image; and
using the second software and the at least one hardware image processing unit to perform the display compensation correction on the mixed reality image, according to the eye movement signal and the motion perception information.

7. The image processor according to claim 6, wherein the step of using a third software configured in the software processing unit and the at least one hardware image processing unit, to perform layer mixing on the virtual rendering image that has undergone the optical correction and the real scene image, according to the eye movement signal and the motion perception information, to obtain a mixed reality image comprises:
obtaining interaction information between the real scene image and the virtual rendering image;
using the third software and the at least one hardware image processing unit to perform the layer mixing on the virtual rendering image that has undergone the optical correction and the real scene image, according to the eye movement signal, the motion perception information and the interaction information.

8. The image processor according to claim 1, wherein the display pipeline is further configured to:
using a fourth software configured in the software processing unit and the at least one hardware image processing unit, to perform color enhancement on the virtual rendering image that has undergone the optical correction, or the mixed reality image, according to the eye movement signal and the motion perception information, to obtain a color enhanced image; and
using the second software and the at least one hardware image processing unit to perform the display compensation correction on the color enhanced image, according to the eye movement signal and the motion perception information.

9. The image processor according to claim 1, wherein the at least one hardware image processing unit further comprises a hardening calculation circuit, including at least one of a weighted sum circuit, a mean calculation circuit, a filtering circuit and a mapping circuit for pixel position relationship, and the display pipeline is further configured to:
using a fifth software configured in the software processing unit and the at least one hardware image processing unit, to perform spatial distortion correction on the virtual rendering image, according to the eye movement signal; and/or
using a sixth software configured in the software processing unit and the at least one hardware image processing unit to perform composite compression processing on the virtual rendering image, according to the eye movement signal.

10. The image processor according to claim 9, wherein the step of using a sixth software configured in the software processing unit and the at least one hardware image processing unit to perform composite compression processing on the virtual rendering image, according to the eye movement signal comprises:
obtaining the eye movement signal of the user, and obtaining the virtual rendering image to be processed;
determining a gaze region and a non-gaze region in the virtual rendering image, according to the eye movement signal; and
performing super-resolution processing on the gaze region and perform compression processing on the non-gaze region to obtain a composite compressed image.

11. The image processor according to claim 10, wherein the step of performing super-resolution processing on the gaze region comprises:
performing eye tracking calculation according to the eye movement signal to determine a gaze point position of the user in the virtual rendering image;
constructing an updated compression model, according to the gaze point position; and
determining coordinates of multiple partitions regarding the gaze point position, according to compression parameters of the updated compression model, wherein the multiple partitions include at least one the gaze region.

12. The image processor according to claim 11, wherein the step of performing super-resolution processing on the gaze region further comprises:
determining an upsampling magnification of at least one gaze region containing and/or adjacent to the gaze point position, according to the compression parameters of the updated compression model; and
performing corresponding super-resolution processing on each of the gaze regions of the virtual rendering image to obtain the compressed image, according to the coordinates and upsampling magnification of each of the gaze regions.

13. The image processor according to claim 11, wherein the step to perform compression processing on the non-gaze region comprises:
determining the downsampling magnification of at least one the non-gaze region far from the gaze point position, according to the compression parameters of the updated compression model; and
performing corresponding compression processing on each of the non-gaze regions of the virtual rendering image to obtain the composite compression image, according to the coordinates and downsampling magnification of each of the non-gaze region.

14. The image processor according to claim 9, wherein the step of using a sixth software configured in the software processing unit and the at least one hardware image processing unit to perform composite compression processing on the virtual rendering image, according to the eye movement signal comprises:
using the sixth software configured in the software processing unit and the at least one hardware image processing unit to perform super-resolution processing on the virtual rendering image, and using the sixth software configured in the software processing unit and the at least one hardware image processing unit to perform compression processing on the virtual rendering image according to the eye movement signal, to obtain the composite compressed image.

15. The image processor according to claim 9, wherein a first memory is used to store pixel data at multiple positions of a current frame of the virtual rendering image to be processed, and/or pixel data at multiple positions of at least one historical frame of the virtual rendering image, for preforming composite compression processing on the current frame of the virtual rendering image.

16. An image processing method, comprising following steps:
obtaining an eye movement signal and motion perception information of a user, and obtaining a virtual rendering image to be processed;
using a first software configured in a software processing unit and at least one hardware image processing unit to perform optical correction on the virtual rendering image, according to the eye movement signal and the motion perception information; and
using a second software configured in the software processing unit and the at least one hardware image processing unit to perform display compensation correction on the virtual rendering image, according to the eye movement signal and the motion perception information.

17. A computer-readable storage medium, storing a computer instruction thereon, wherein when the computer instruction is executed by a processor, the image processing method according to claim 16 is implemented.

18. An extended reality display device, comprising:
an eye tracker, used to collect an eye movement signal of a user;
a motion sensor, used to collect motion perception information of the user;
a main processor, used to output a virtual rendering image to be processed;
an image processor according to claim 1, wherein the image processor is respectively connected to the eye tracker, the motion sensor and the main processor to obtain the eye movement signal, the motion perception information and the virtual rendering image; and
a display terminal, connected to the image processor to obtain and display a corrected image that has undergone optical correction and display compensation correction performed by the image processor.

19. The extended reality display device according to claim 18, further comprising a camera, wherein the image processor is further connected to the camera, and configured to:
obtaining a real scene image to be processed through the camera;
using a software processing unit and at least one hardware image processing unit configured in the image processor, to perform layer mixing on the virtual rendering image that has undergone the optical correction and the real scene image, according to the eye movement signal and the motion perception information, to obtain a mixed reality image; and
using the software processing unit and the at least one hardware image processing unit to perform display compensation correction on the mixed reality image, according to the eye movement signal and the motion perception information.
